(19) United States
(12) Patent Application Publication
(10) Pub. No.: US 2006/0069660 A1
(43) Pub. Date: Mar. 30, 2006

(54) Methods and apparatus for monitoring equipment productivity

(76) Inventors: Matthew L. Vogen, Oconomowoc, WI (US); Sandra L. Vogen, Oconomowoc, WI (US)

Correspondence Address: Richard M. Saccocio;Richard M. Saccocio, P.A., 100 S.E. 12th Street, Ft. Lauderdale, FL, 33316, US

(21) Appl. No.: 10/954,427

(22) Filed: Sep. 30, 2004

(51) Int. Cl. G06F 17/00

(52) U.S. Cl. 705/400

(57) ABSTRACT

The disclosed invention comprises methods and apparatus for affordably optimizing the efficiency and cost effectiveness of manufacturing one or more production parts from one or more production machines. A preprogrammed microprocessor receives and stores, data from sensors attached to a production machine and transmits the data to an Ethernet hub which in turn transmits the data to a production monitoring computer. The data allows for adjusting the controls of the machine to optimize the operations of the machine to either maximize production, to minimize the costs of the operations, or to increase the efficiency of the operations.

### BACKGROUND OF THE INVENTION

a. Field Of The Invention

This invention relates in general to the field of manufacturing and production and in particular the field of methods and apparatus for monitoring and troubleshooting processing and manufacturing machines using a simple and efficient microprocessor attachable to prior art manufacturing and processing machines

b. Description Of The Prior Art

Manufacturing products generally involves many processing steps and many machines from start to finish of the product being manufactured. For production of products or components than involve a plurality of the same but less than mass production, the steps, for example, might involve set up time for each of the machines involved in the product manufacture; the time for performing one or more operations by each machine, machine malfunctions, down time, running time, scrapping of non conforming products and many other like steps. For mass production of parts or components or the processes in such mass production, additional parameters can be involved such as tool wear, heating or cooling times, quality control checks, optimizing particular steps by using faster or a plurality of the same machines and other like requirements of mass production.

Also, there exist many manufacturing facilities that cannot afford the latest up to date machines or even all of the machines that would provide for efficient and cost cutting manufacturing processes. Such small manufacturing facilities often struggle to make a profit because of the non-ability to efficiently use the machines on hand.

Thus, regardless of the size and equipment of manufacturing facilities and regardless of whether the manufacturing involves small runs or mass production, a great many of manufacturing or production facilities perform the multitude of manufacturing steps in a non-efficient manner because of an essentially complete lack of information and the ability to control the operation and output of any one or more machines. It is therefore difficult if not impossible for a great many of manufacturing facilities to configure the individual manufacturing steps and the overall manufacturing process in an efficient manner so as to maximize production and to minimize wasted time as well as to minimize manufacturing errors resulting in scrapped parts. Without such ability, the manufacturing costs that are factored in the sales price of the goods can cause the sales price to be so high that the product is overpriced and not purchased. Or, without this ability, a manufacturer may not be able to realize the net profits that are required for a successful business venture. Or, the manufacturer may be making a lot less money than what the business is capable of generating.

What is needed are apparatus and methods that allow production shops to generate the information that will reveal exactly what is occurring and the time involved in every aspect of the operation of each machine and for the overall manufacturing or production process and to control the same. With such information and control, inefficiencies can be corrected, costs can be reduced, and production can be maximized. Such apparatus and methods need to be adaptable to both old and new machines of manufacturing facilities. Such apparatus and methods need to be inexpensive, easy to install, easy to operate and, of course, generate the necessary data so that proper evaluation the information generated can be made and allow the necessary controls to increase productivity.

The present invention accomplishes these objectives.

### SUMMARY OF THE INVENTION

The above-stated objects as well as other objects which, although not specifically stated, but are intended to be included within the scope the present invention, are accomplished by the present invention and will become apparent from the hereinafter set forth Detailed Description of the Invention, Drawings, and Claims appended herewith. The present invention accomplishes these objectives by providing a preprogrammed microprocessor attached and connected to a machine that receives data from the machine, relays the data to a local server such as an Ethernet hub, which in turn will transmit the data to a preprogrammed computer where a report can be generated. An analysis of the report will allow adjustments to be made to the machine to increase the overall efficiency. By providing each machine with the inventive apparatus and connecting the plurality of microprocessors to the preprogrammed computer 65, the overall efficiency of the production or manufacturing process can be maximized and scrappage minimized.

In accordance with the above, there has been summarized the more important features of the present invention in order that the detailed description of the invention as it appears in the below detailed description of the same, may be better understood.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic block flow diagram of the basic apparatus used with the inventive method.

FIG. 2 is an example of the microprocessor to be attached to a production machine; and,

FIG. 3 is a schematic block flow diagram of one arrangement of the electrical connection of the microprocessor to the machine sensors, to an Ethernet hub and to a local network.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure. Additionally, the verbiage used herein is intended to better enable a person to understand the invention and therefore, such verbiage is not to be interpreted as limiting the invention.

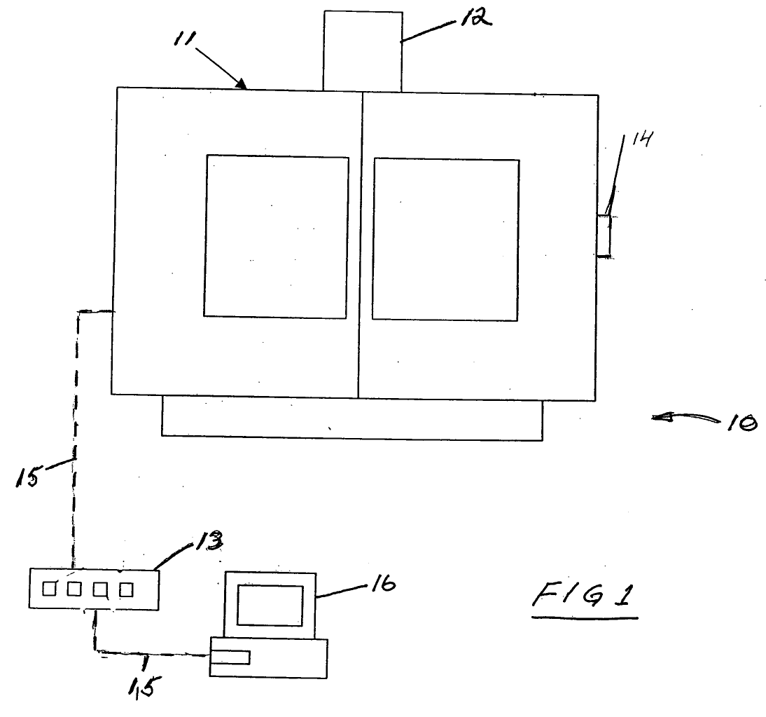

Reference is now made to the drawings, wherein like the characteristics and features of the present invention shown in the various figures are designated by the same reference numerals. FIG. 1 illustrates a basic embodiment 10 of the apparatus and method of the present invention. A production machine 11 can comprise an old relay logic machine or a new computerized machine; thus, the invention is not limited to only modern highly technical production facilities. The production machine 11 can consist of virtually any type of prior art machine that is provided with circuitry that controls one or more operations of the machine that is intended to be repeated by the machine. A preprogrammed microprocessor 12 is attached to and electrically connected to the machine 11. The microprocessor 12 might be programmed to receive common data such as time to perform an operation, the time between individual operations, the total time from start to finish of the particular operation of the machine, the time between one part is finished and another begins and other such standard operating parameters and might be programmed to receive specialized data such as dimensional data of the part being produced, coolant temperatures, etc. Prior art sensors appropriately attached to the machine 11 sense the production data. The sensed data is then input to the microprocessor 12 either continuously or at appropriate intervals and is received by a production monitor 14 that allows an operator to view the data

An Ethernet hub 13 acting as a server is electronically connected to the microprocessor 12 either by appropriate cables 15 or even by radio waves. Thus, the microprocessor 12 collects the data from the sensors, and relays the data to the Ethernet hub 13. The Ethernet hub 13 acts as an accumulating coordinator and incrementally sends the various data via another electrical cable 15 to a production monitoring computer 16. The production monitoring computer 16 is then used to print reports of the performance of the production machine 11, the reports are analyzed and appropriate changes can be made to correct any discovered problem or vary the production process to increase the overall efficiency.

The above described method and apparatus is of course the very basic aspect of the invention 10. However, even when applied to a single CNC machine, the advantages of the inventive system are easily understood. The invention quickly and effortlessly provides an operator or production manager with the ability to verify that the programming of the CNC is optimal, or if it is not, then the individual operations can be reprogrammed to provide optimization.

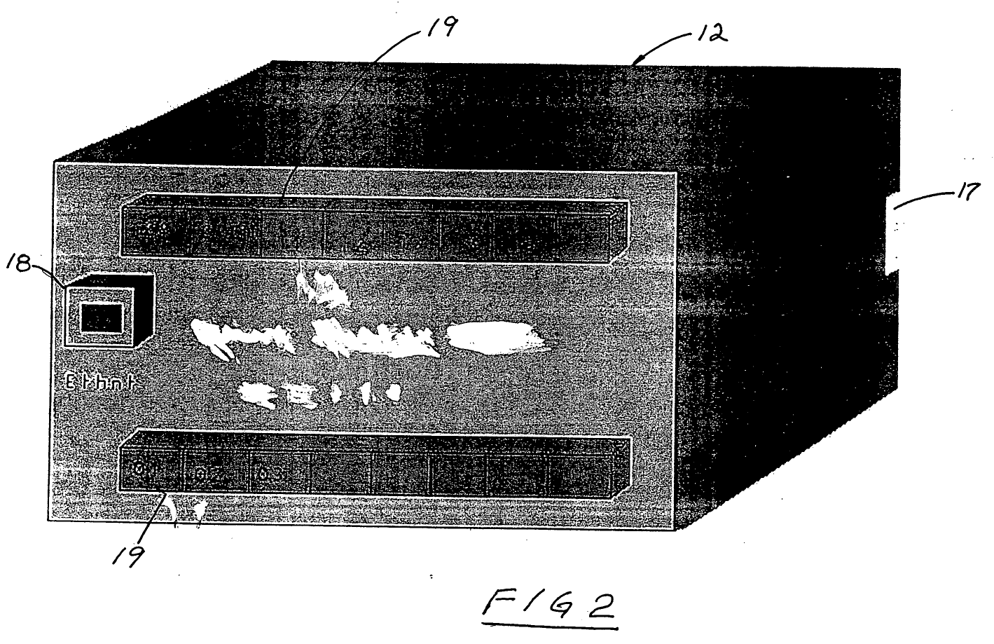

The microprocessor 12 shown in FIG.2 is one of many configurations the microprocessor 12 can assume in the practice of the invention 10. As such, the microprocessor 12 is of a relatively small overall configuration that allows for non-intrusive attachment to a machine 11. The microprocessor 12 can be powered by a standard 24 volt, direct current voltage supply. This allows, for example, an in house electrician with no special training to connect the microprocessor 12 to a machine 11. The microprocessor 11 can include attachment means 17 located at the back of the microprocessor such that it can be directly attached to the DIN rail of the machine 11 and powered by a 24V power supply provided by an external power source. The face of the microprocessor 12 can be arranged to include a quick connect socket 18 for the Ethernet cable 14, a quick connect arrangement 19 for the power leads of the 24V power supply within one or more rows of quick connects 19, arranged in an appropriate fashion, e.g. side by side, for connecting electrical wiring from each of the sensors that are connected to the various production parameters of the machine 11. By locating the electrical connectors 19 on the front of the microprocessor 12, the connections can be made very quickly and easily, and this arrangement allows for immediate viewing and troubleshooting of the various connections. Spare connectors are also provided on the face of the microprocessor 12 to provide for universal use of the microprocessor 12 to different machines 11.

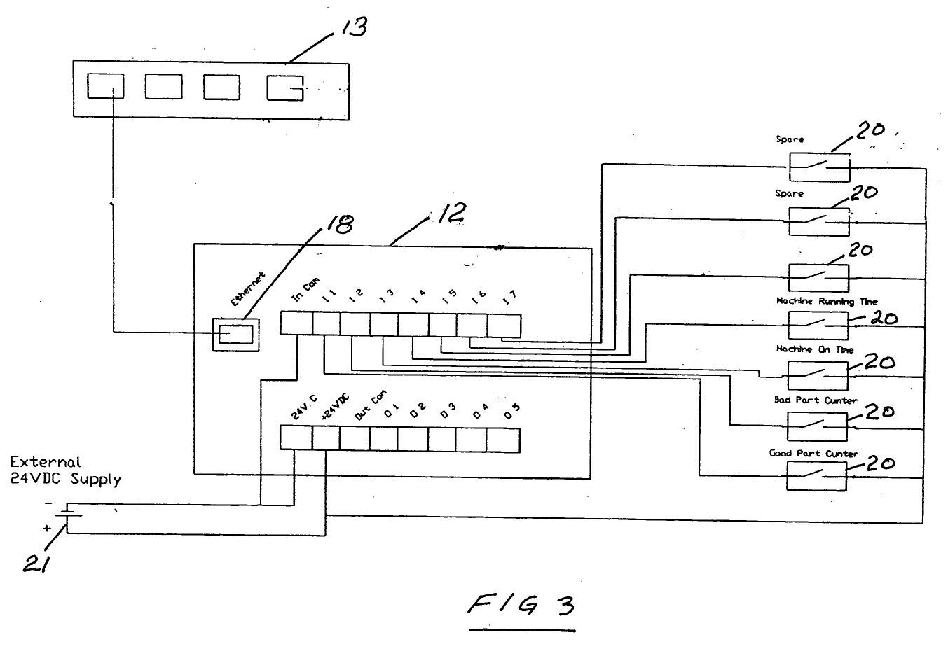

FIG. 3 schematically shows a typical electrical arrangement of the present invention 10 as it is applied to a single production machine 11 The Ethernet hub 12 is connected to the microprocessor 12 by the cable 15. The outside power source for the microprocessor 12 is connected to the power import connections of the microprocessor 12. A plurality of sensors 20 are individually attached to the production machine 11 as is well known in the art. For example, one sensor can be connected to the machine run time, another to the machine on time, another to the machine down time, another to the machine parts counter, another to the machine scrap parts counter, another to the machine good parts counter, another to the time on to the time of the beginning of the first operation of the machine, another to the time for each different operation of the machine, for example. As explained above, the electrical leads from the sensors 20 are routed and connected to the face of the microprocessor 12 so that the connections can be easily made and easily viewed to assure that all of the connections are properly made. This arrangement also allows for the simple and quick changing of and or addition of new sensors 19. FIG. 3 also shows how simple and quick the 24V power supply 21 can be made to the microprocessor 12.

In the use of the inventive apparatus and methods as shown in FIG. 3, a particular production machine 11 is provided with a preprogrammed microprocessor 12. The sensors 19 are attached to the machine 11 consistent with the program previously input to the microprocessor 12. The microprocessor 12 is connected to the production monitor 12 and Ethernet hub 13 which in turn is connected to the production monitoring computer 16. The machine 11 is put into operation and the data from the sensors 20 is displayed and stored in the computer 16. Whenever appropriate, the data from the sensors 20 is reviewed. The data will indicate whatever changes are necessary to the controls of the machine 11 to optimize its operation and produce quality parts. In this manner, the inventive apparatus and methods provides a complete history of the operation of the machine 1 land optimize its performance to eliminate inefficiencies that directly affect the costs associated with the production of the parts made by the machine 11.

A production facility can utilize one or more standard microprocessors that are preprogrammed to accept data from common production parameters of particular machines such as milling machines, lathes, boring machines, etc. that are equipped with the sensors 19 to provide data associated with typical operations. The output of the typical operations are input to the standard microprocessor and associated Ethernet hub and then to a production monitor computer, the later being programmed to analyze the data and print a report that can allow for a determination of what production changes need to be made to increase efficiency and minimize down time and scrappage. Or, a production facility having specialized needs can have one or more microprocessors 12 that are specially preprogrammed for a specialized machine or machines that are integrated with the standard machines to produce the production parts. In either situation, the microprocessors 12 from each of the machines are connected to the Ethernet hub 13 such that a complete production history of individual parts that are sequentially processed from one machine to another is provided and able to be analyzed for the most efficient production.

If desired, or necessary, depending on the complexity of the part being manufactured at a production facility, additional Ethernet hubs can be connected to the production computer to provide a complete analyses of the manufacturing steps by each machine in making the complex part. Or, the output from one or more of the Ethernet hubs can be directed to one or more production computers to provide a network arrangement. In this manner, any number of machines 11 and microprocessors 12, can be networked and the data from all machines 11 can be monitored by the computer 15 further, because the Ethernet hub allows for the connection of additional production monitors 15 to be connected to the network. The use of a plurality of production monitors 15 allows for the production data generated by the inventive arrangement 10 to be simultaneously reviewed by a number of production personnel.

In accordance with the above, the inventive methods and apparatus provide a production facility comprising a single machine or a production facility comprising a large plurality of machines, to easily and economically optimize the efficiency of the manufacturing facility and minimize the production costs. Indeed, the inventive apparatus and methods can provide any sized production facility with manufacturing information that is invaluable to a company's net profits and financial security.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breath and scope of the drawings, claims and description provided herein.

We Claim:

1. A method for affordably optimizing the efficiency and cost effectiveness of manufacturing one or more production parts from one or more production machines comprising the steps of:
determining the operating parameters of one or more machines taken from the group of operating parameters to maximize production from the machine, to minimize the costs of production, or to increase the efficiency of production;
preprogramming one or more microprocessors to receive, store, and transmit the predetermined operating parameters
connecting one or more sensors to the one or more machines in accordance with the determined operating parameters;
connecting the output of the sensors to the one or more microprocessors;
connecting the microprocessor to one or more Ethernet hubs;
connecting the one or more Ethernet hubs to one or more production computers;
operating the one or more machines whereby data from the one or more sensors is transmitted to the one or more microprocessors, from the one or more microprocessors to the one or more Ethernet hubs and from the one or more Ethernet hubs to the one or more production computers.

2. The method of claim 1, including the step of evaluating the data.

3. The method of claim 1 including the step printing the data.

4. The method of claim 1, including the step of adjusting the controls of the one or more machines to optimize the operations of the one or more machines taken from the group of operating controls to maximize production, to minimize the costs of the operations, or to increase the efficiency of the operations.

5. The method of claim 1, including the steps of connecting the one or more machines, connection the one or more microprocessors, connecting the one or more Ethernet hubs, and connecting the one or more production computers in a network arrangement.

6. Apparatus for affordably optimizing the efficiency and cost effectiveness of manufacturing one or more production parts from one or more production machines comprising
one or more microprocessors preprogrammed to receive, store, and transmit data, said data taken from the group of operating parameters of said one or more production machines to maximize production from the machine, to minimize the costs of production, or to increase the efficiency of production,
one or more sensors connected to said machine and to said microprocessor one or more Ethernet hubs connected to said one or more microprocessors, one or more production monitoring computers connected to said one or more Ethernet hubs,
whereby the output of said one or more sensors is input to said one or more preprogrammed microprocessors, the output of said one or more microprocessors is input to said one or more Ethernet hubs, and the output said one or more Ethernet hubs is input to said one or more production monitoring computers.

7. The apparatus of claim 6 including said one or more microprocessors, said one or more Ethernet hubs, and said one or more production monitoring computers being arranged in a network.
